(19) United States
(12) Patent Application Publication
(10) Pub. No.: US 2008/0127283 A1
(43) Pub. Date: May 29, 2008

(54) PROGRAM SERVER AND A RECEIVER

(75) Inventor: Gen Sasaki, Osaka (JP)

Correspondence Address: Rutan & Tucker, LLP., 611 ANTON BLVD, SUITE 1400, COSTA MESA, CA, 92626, US

(73) Assignee: Gen Sasaki, Osaka (JP)

(21) Appl. No.: 11/929,513

(22) Filed: Oct. 30, 2007

Related U.S. Application Data
(62) Division of application No. 10/222,492, filed on Aug. 16, 2002.

(30) Foreign Application Priority Data
Sep. 3, 2001 (JP) JP 2001/312012
Apr. 30, 2002 (JP) JP 2002/164960

(51) Int. Cl. H04N 7/173

(52) U.S. Cl. 725/88

(57) ABSTRACT

A broadcast program is contiguously stored to a real-time storage means in a program server. The stored program is read from the real-time storage means and sent to a receiver when the receiver sends a request to the program server to send the stored program to the receiver so that the receiver may show the stored program. Retrieval of the stored program is similar to replaying a program stored on a video tape recorder.

This application is a divisional application of and claims priority to U.S. Non Provisional patent application Ser. No. 10/222,492 filed on Aug. 16, 2002, and claims priority and benefit to Japanese Patent Application No. JP 2001/312012 filed Sep. 3, 2001, and claims priority and benefit to Japanese Patent Application No. JP 2002/164960 filed Apr. 30, 2002.

### BACKGROUND OF THE INVENTION

1. Field of the Invention

The present invention is related to a broadcasting system and a receiver for contiguously broadcast television or radio programs.

2. Description of the Background Art

FIG. 10 indicates a conceptual diagram of a traditional television (TV) system 5. FIG. 11 indicates a conceptual diagram of a video on demand (VOD) system. FIG. 12 indicates a conceptual diagram of a traditional digital television (DTV) system 13, a World Wide Web browsing system, and a video streaming system on a personal computer (PC). These days, contiguously broadcast programs can be received not only by TV 5 but also by DTV 13 or PC 12. The programs can be transferred by individual transferring means such as an Internet protocol (IP) connection via an Internet line 10 such as a telephone line or a cable TV line 10A. Transferred information may come from a VOD server 19 or a video streaming server 61. The VOD server 19 provides programs that are read from a storage device 8 at the request of the viewer. The storage device 8 stores programs prior to the request. The video streaming server 61 provides programs to a plurality of PCs at the same time.

A broadcast program for the traditional TV system in FIG. 10 can be seen after the time of broadcasting by recording the program on a video tape recorder (VTR) 18. But the VTR 18 can't record for a period longer than the amount of time the videotape is intended to record. Furthermore, if a viewer wants to watch a program after the program has already been broadcast, but he fails to record the program on a VTR, then the VTR 18 is not a viable solution.

The VOD server system provides movies or TV programs for viewers on demand. FIG. 11. The VOD programs are prepared from a list of predetermined movies, or from TV programs which a large percentage of viewers want to watch again. Unfortunately, not all broadcast TV programs are prepared for a VOD server 19 and it takes a long time to register a selected TV program on a VOD server 19. A broadcast TV program is selected according to the process illustrated by the flow chart in FIG. 13. The step of selecting a TV program (H21) and the step of transferring the TV program to a VOD server 19 from a broadcast station are required to register the TV program for the VOD server 19. Usually it takes several days or several weeks. This means it's difficult to watch the TV program just after the program has been broadcast. There are some restricted World Wide Web servers that store programs from broadcast stations and provide them to PCs on a World Wide Web browser scheme. But it's difficult for elderly people and children, who are not familiar with PCs, to watch the stored programs on PCs.

A traditional video streaming system has several problems. The data flow of all transactions is done on the IP connection on the Internet line 10. This prevents increasing the resolution of a streamed program because of the Internet line's data bandwidth restriction. Furthermore, the live streaming program takes a long time to record to the streaming server 61, so the live program can't be watched immediately after the broadcast.

Recently, the hard disk recorder has become popular. With its plentiful disk space, this device can record programs for a long period of time. But two programs that are concurrently broadcast on different broadcast stations can't be simultaneously recorded on the hard disk recorder because the recorder only has one tuner. The number of tuners can be increased but multiple tuners consume excessive power, and receivers are expensive.

Recently, DTV systems have also become popular. The DTV 13 has some bi-directional data transferring means similar to those of a telephone line, but the bi-directional data transferring means are used only for browsing Internet websites, downloading electronic program guides, or sending commands for purchasing the products that are shown on a TV program. It's still impossible to record and replay for very long periods of time, or to watch a previously broadcast program without having to record the program. Finally, it's also impossible to watch concurrently broadcasted programs.

Commercials are another problem for VOD programs. Traditional VOD programs are mainly part of a contract to pay money for providing the program, so there are basically no commercials on a VOD system. But when a normal broadcast program is served as a VOD program, it is difficult to add the program commercials to the program on a VOD system.

### SUMMARY OF THE INVENTION

According to a first aspect of the present invention, a method of controlling a program server comprises concurrently broadcasting a program from the program server to a plurality of receivers, storing the broadcast programs contiguously on a storage device, and sending a program which is read from the storage device to an individual receiver when the receiver sends a request for a previously broadcast program to the program server.

According to a second aspect of the present invention, a method of controlling a program server includes broadcasting programs using a medium other than an Internet protocol connection and sending a program to an individual receiver over an Internet protocol connection.

According to a third aspect of the present invention, a method of controlling a program server comprises sending a stored program backwards starting from the most recently stored information, to an individual receiver.

According to a fourth aspect of the present invention, a method of controlling a program server comprises sending a stored program forward starting from a past point in time indicated by a request from the receiver, to an individual receiver.

According to a fifth aspect of the present invention, a method of controlling a program server comprises sending a stored program forward starting from a time stepped back from the current program time at a predetermined period, to an individual receiver.

According to a sixth aspect of the present invention, a method of controlling a program server comprises sending an advertisement with a stored program to the individual receiver.

According to a seventh aspect of the present invention, a method of controlling a program server comprises sending an advertisement to a receiver that has a contract for receiving an advertisement, and sending no advertisements to a receiver that has a contract for receiving advertisement-free programs.

According to an eighth aspect of the present invention, a method of controlling a program server comprises keeping track of the advertisements sent to a receiver.

According to a ninth aspect of the present invention, a method of controlling a program server comprises sending an advertisement to an individual receiver before a stored program is sent.

According to a tenth aspect of the present invention, a method of controlling a program server comprises merging an advertisement with a stored program when the stored program includes image information.

According to an eleventh aspect of the present invention, a receiver comprises a tuner for a broadcasting program, an individual data transceiver for a stored program on a program server, a selector that takes as inputs the tuner's output and the individual data transceiver's output and outputs a selected program to a display unit, and a controlling means for changing a program to the display unit from a broadcast program to a stored program in response to the receiver's request for a previously broadcast program to the program server when the user makes, on the receiver or on a remote controller of the receiver, an operation for viewing or hearing a program previously broadcast by the current broadcast station.

According to a twelfth aspect of the present invention, a remote controller includes a dedicated button for requesting a program server to send a stored program backwards starting from the most recently stored information.

According to a thirteenth aspect of the present invention, a remote controller includes a dedicated button for requesting a program server to send a stored program forward starting from a past indicated time.

According to a fourteenth aspect of the present invention, a remote controller includes a dedicated button for requesting the program server to send a stored program forward starting from a time stepped back from the current program time at a predetermined period.

According to a fifteenth aspect of the present invention, a remote controller includes a dedicated button for switching to the broadcast program when the stored program is currently being shown.

According to a sixteenth aspect of the present invention, a method of controlling a program server for a plurality of broadcast stations comprises concurrently and contiguously storing a plurality of programs from a plurality of broadcast stations to a storage device, bi-directionally transferring data between the program server and an individual receiver, and sending a program from the storage device to the individual receiver in response to the receiver's request for sending a program identified by its broadcast station and its original broadcast time.

According to a seventeenth aspect of the present invention, a method of controlling a program index server for a plurality of broadcast stations comprises concurrently and contiguously storing a plurality of indexes for a plurality of programs from a plurality of broadcast stations to an index storage device, bi-directionally transferring data between the program index server and an individual receiver, and sending an index from the index storage device to the individual receiver or to a program server that is actually storing a plurality of programs of at least one broadcast station in response to the receiver's request to the program index server for sending a program identified by its broadcast station and its original broadcast time.

According to an eighteenth aspect of the present invention, a method of controlling a program server comprises searching a plurality of programs using a keyword that is sent from the receiver, then sending the results to the receiver in series.

According to a nineteenth aspect of the present invention, a method of controlling a program index server comprises searching a plurality of indexes using a keyword that is sent from the receiver, then sending the results to the receiver or a program server in series.

According to a twentieth aspect of the present invention, a method of controlling a program server comprises sending a stored program broadcast by a different broadcast station but during the same time slot as the program currently being sent to the receiver in response to the receiver's request to switch to the other broadcast station.

According to a twenty-first aspect of the present invention, a method of controlling a program index server comprises sending to a receiver or new program server the index for a program broadcast by a different broadcast station but during the same time slot as the program currently being shown, in response to the receiver's request to the program index server for switching to the new broadcast station.

According to a twenty-second aspect of the present invention, a method of controlling a program server or a program index server comprises sending a program table that includes information for a plurality of broadcast programs by a plurality of broadcast stations for the time slot during which the currently shown program was originally broadcast.

According to a twenty-third aspect of the present invention, a receiver comprises a means for indicating a broadcast station, a means for indicating the time of a program, and a controlling means for sending a request for a stored program of an indicated broadcast station forward starting from a past indicated time to a program server or to a program index server when the indicated time is in the past.

According to a twenty-fourth aspect of the present invention, a receiver comprises a local program storage device wherein a controlling means reads a stored program from the local program storage device when the indicated program of the indicated broadcast station is stored in the local program storage device.

According to a twenty-fifth aspect of the present invention, a receiver includes an operation mode where all information for a stored program is downloaded before the downloaded program is shown.

According to a twenty-sixth aspect of the present invention, a receiver includes a function that sends a request for a new stored program by a new broadcast station, the new stored program having approximately the same broadcast time as the currently shown program, to a program server or to a program index server when the broadcast station setting is changed by the receiver or a remote controller of the receiver while a stored program is being shown.

### BRIEF DESCRIPTION OF THE DRAWINGS

FIG. 1 is a conceptual diagram of a program server system of embodiment 1.

FIG. 2 is a flow chart explaining a controlling algorithm of an individual transferring controller and a storage device of embodiment 2.

FIG. 3 is an example of merging an image from a stored program and an advertisement of embodiment 2.

FIG. 4 is an example of merging an image from a stored program and a differently positioned advertisement of embodiment 2.

FIG. 5 is an example of merging a part of an actual image from a stored program and an advertisement of embodiment 2.

FIG. 6 is a block diagram of a receiver of embodiment 3.

FIG. 7 is a flow chart explaining a controlling algorithm for a receiver of embodiment 3.

FIG. 8 is an example of an arrangement of buttons for a remote controller of embodiment 4.

FIG. 9 is an example of an arrangement of buttons for a remote controller of embodiment 5.

FIG. 10 is a conceptual diagram of a traditional TV broadcasting system.

FIG. 11 is a conceptual diagram of a traditional VOD server system.

FIG. 12 is a conceptual diagram of a traditional DTV broadcasting system, a World Wide Web browsing system, and a video streaming system.

FIG. 13 is a flow chart explaining a procedure to register and provide an already broadcast program as a VOD program.

FIG. 14 is a flow chart explaining a controlling algorithm for a program server of embodiment 1.

FIG. 15 is a conceptual diagram of a program server system of embodiment 6.

FIG. 16 is a conceptual diagram of a program index server system of embodiment 7.

FIG. 17 is a flow chart explaining an algorithm for controlling a program server system of embodiment 6.

FIG. 18 is a flow chart explaining an algorithm for controlling a program index server system of embodiment 7.

FIG. 19 is a flow chart explaining a controlling algorithm for a receiver of embodiment 8.

FIG. 20 is a block diagram of a receiver of embodiment 9.

FIG. 21 is a flow chart explaining a controlling algorithm for a receiver of embodiment 9.

FIG. 22 is a flow chart explaining a controlling algorithm for “Batch Mode” of a receiver of embodiment 9.

### DESCRIPTION OF THE PREFERRED EMBODIMENTS

### Embodiment 1

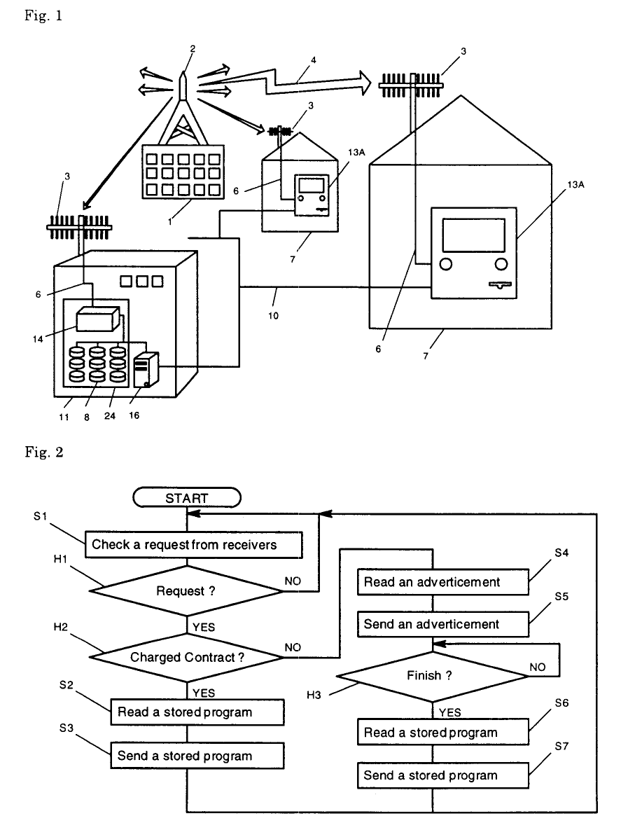

FIG. 1 is a conceptual diagram of preferred embodiment 1. This program server system adopts a method of the present invention. The broadcast station 1 transmits a program to a plurality of receivers on a radio wave 4 via a transmitting antenna 2. The TV or radio receiver receives the program by receiving the radio waves through a receiving antenna 3 at each house 7. This broadcast program is stored in a real-time storage means 24 at a program storing center 11 in parallel with the broadcasting. The huge volume storage device 8 is equipped with real-time storage means 24. The storage device comprises a video tape recorder, digital video disk recorder or hard disk drive. In this example, the program storing center 11 is located in a separate building from the broadcast station, and the receiving antenna 3 is equipped in the same way as the antenna for house 7.

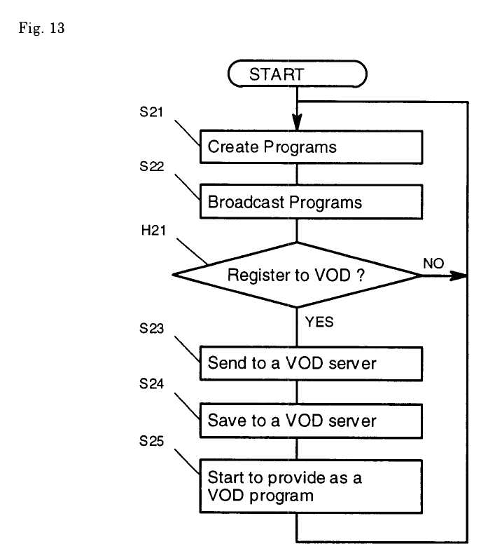

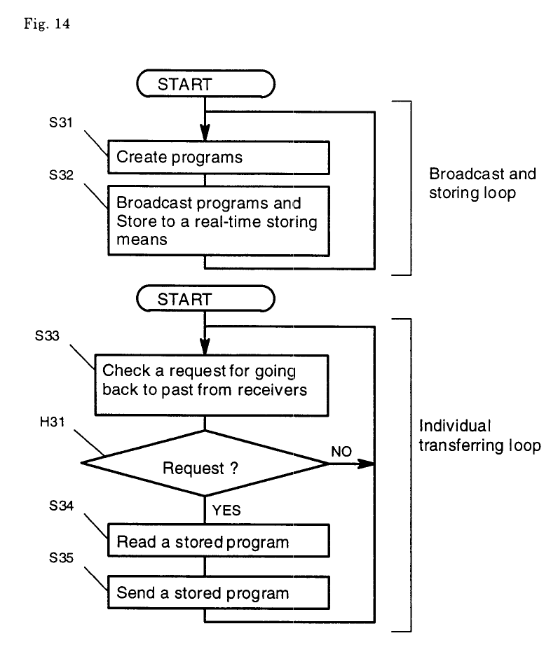

Real-time storage means 24 and an individual transferring controller 16 have a different flow than a traditional VOD system indicated by FIG. 13. In FIG. 14, there is a loop operation for broadcasting and storing. The loop includes creating the program (S31) and contiguously broadcasting and storing the program (S32). In parallel with the above loop, there is another loop operation controlling the individual transfer. The individual transferring controller 16 is always checking for a request for a previously broadcast program from a DTV 13A (S33), one of the receivers of the present embodiment. When there is a request, the controller reads a stored program from the real-time storage means 24 (S34) and sends the program to the DTV 13A.

The program storing center 11 can be located in a building separate from the building for broadcast station 1. Alternatively, it may be located in the broadcast station itself. In the latter case, the broadcast program is easily and directly transferred to the real-time storage means 24 without using the radio waves. When a viewer is watching a broadcast program, the program information is broadcast on radio waves to a plurality of receivers.

When the viewer wants to watch a portion of the program broadcast just prior to the portion being shown, an operation for rewinding the current program is done on the DTV 13A or on a remote controller for it. The DTV 13A sends a request for rewinding a stored program to the individual transferring controller 16 on a bi-directional data transferring means such as an IP connection. When the individual transferring controller 16 gets the request, it reads a predetermined period of the recently-stored portion of the program being currently broadcast, sets up a peer to peer connection from the individual transferring controller 16 to the DTV 13A, and sends the program information backwards starting from the newest most recently stored information to the oldest information. The DTV 13A changes the program being shown from the currently broadcast program to the stored program. With this operation, a viewer can watch a broadcast program backwards in the same way that a recorded program can be viewed on VTR.

When the viewer wants to watch a program starting from an indicated past point in time during the currently broadcast program, that time is indicated on the remote controller or on the DTV 13A itself before a button for skipping back to the indicated time is pushed. A request for sending the stored program portion that starts at the indicated time is then sent to the individual transferring controller 16 over the IP connection via an Internet line 10 such as a telephone line or a cable TV line 10A. After this, the individual transferring controller 16 reads the stored program portion that starts at the indicated time from the storage device 8 and sends it to the DTV 13A. With this operation, a viewer can watch a program starting at an indicated point in time. For example, one can watch from the starting point of a broadcast program. With this operation a viewer can watch a previously broadcast program in a manner similar to step rewinding a program recorded on the VTR without having to use a huge VTR recording system on the receiver side.

When the viewer wants to search the program by watching the starting point of each program, he or she can push a button for skipping back at some predetermined step. The DTV 13A then sends a request for sending a stored program portion stepped back at a predetermined period. With this operation, it's better to go back to some special time. For example, most of the programs start at 0 minutes, 15 minutes, 30 minutes, or 45 minutes past the hour. So these points can be good candidates for the first point to rewind to. The next request would result in another fifteen-minute rewind. Of course it can be a good operation to go back to the actual start point of the program instead of the concrete time.

In embodiment 1, a viewer can watch a previously broadcast program just after it has been broadcast, in the same manner as watching a program recorded on a local VTR, without waiting for the program's VOD registration. This embodiment doesn't require a huge recording space on the receiver side. Moreover, this embodiment doesn't require setting a recording appointment prior to the broadcast. There is no limitation for watching previously broadcast programs. A viewer can watch programs broadcast at the same time if each station broadcasts to the program server. A viewer can watch many previously broadcast programs from many different broadcast stations. It is important to this embodiment that a program server and a receiver cooperate with each other. There are some restricted World Wide Web servers for a World Wide Web browser that are similar to this embodiment, but the World Wide Web browser requires users to be familiar with a PC and the World Wide Web site system. For children and elderly people, it's difficult to use a World Wide Web browser on PCs or Web-TVs. For example, using the mouse to choose a menu is difficult for these users. But in this embodiment, a viewer can watch a previously-broadcast program on a program server by just selecting a channel and pushing a rewind button. This is almost the same operation as watching a currently broadcast program on TV and then playing back a program stored on VTR. These operations are very convenient not only for elderly people and children but also for anyone who is watching the DTV 13A because the operations for watching a previously broadcast program are extremely simple.

It doesn't matter that the broadcasting is done via a radio wave or via an IP connection. However, when the broadcasting is done on an IP connection, the total transaction becomes huge if many people want to watch broadcast programs and stored programs. The limited bandwidth of the IP connection may reduce the image resolution of the broadcast, so it's better to broadcast programs via media such as radio waves or cable TV network and to transfer a program individually on the IP connection.

When a receiver requests to fast forward to a newer program while a stored program is currently being shown, the individual transferring controller 16 can read a newer stored program and send it to the DTV 13A. This operation is equivalent to the fast forward function on a VTR.

### Embodiment 2

FIG. 2 shows a flow chart for adding an advertisement to the stored program. The individual transferring controller 16 is always checking for rewind requests from a DTV 13A (S1, H1). When it gets the request from a DTV 13A, the individual transferring controller 16 checks the DTV's 13A contract using the data transaction on the IP connection (H2). If the DTV's 13A contract recites providing a stored program in return for a set charge, then the individual transferring controller 16 reads the indicated stored program from a storage device 8 (S2) and immediately sends the program to the DTV 13A without an advertisement (S3). If the contract does not involve a charge, the individual transferring controller 16 sends an advertisement first (S4, S5). The stored program is not sent until the advertisement has been completely sent (H3). Afterwards, the indicated stored program is read from the storage device 8 (S6) and sent to the DTV 13A (S7). This assures that the advertising client has promoted to a viewer.

If a broadcast advertisement is shown in the same way as a program, a viewer can easily skip the advertisement with a fast forward command. The client will then lose the chance to promote to viewers, and the broadcast station may subsequently lose advertisement income. But in embodiment 2, an advertisement is managed separately from usual programs, so the chance to promote is assured.

The individual transferring controller 16 can keep track of how many times an advertisement is sent to a DTV 13A. The number of advertisements can be used for measuring the popularity of the program and as a metric for determining the advertising fee for a client or the bonus for a program producer. Common broadcast programs use criteria such as the watching rate (i.e. the percentages of viewers watching particular programs) to determine the bonus or advertising fee. But the watching rate is calculated from sampled viewers, so it's not very accurate. On the other hand, counting the number of advertisements sent on this embodiment is very accurate for determining how many viewers watch the advertisements. Therefore very accurate data for evaluating bonuses and advertising fees is available.

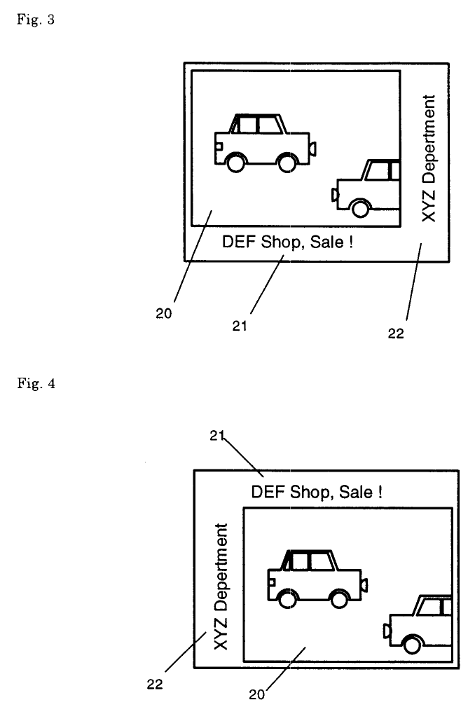

One problem remains in embodiment 2. If a viewer isn't watching the DTV 13A screen while an advertisement is being shown, the chance to promote is lost. To avoid this problem, it's effective to show the advertisement in the marginal area of the program image as shown in FIG. 3.

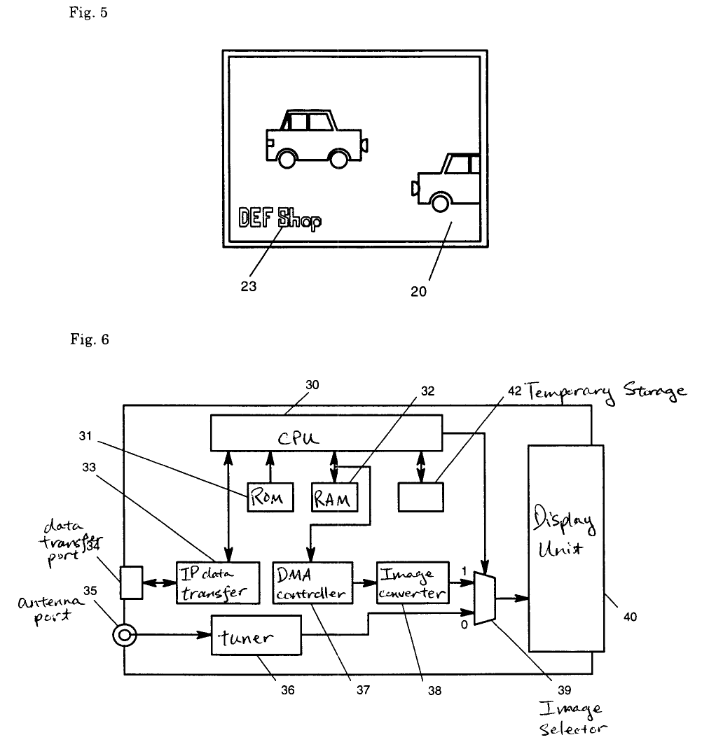

In this case, if the DTV 13A is capable of zooming in on part of the screen, a viewer can zoom in on the program image and expand it to the full screen size so that the advertisement is not in view. To avoid this result, it's effective to change the position of the advertisement from FIG. 3 to FIG. 4 or to merge the advertisement with the program information as shown in FIG. 5. Viewers can't easily mask the advertisement in these cases. When the advertisement is merged with a part of the actual program information, the merging should be done with half transparency to maintain the visibility of the program information.

When sending a stored program, an accompanying advertisement can be the same advertisement as when the program was originally broadcast, but it can also be a different advertisement from the original one. This creates chances to get new advertising clients for the broadcast station.

### Embodiment 3

FIG. 6 is a block diagram of a DTV receiver used for the present embodiment. It comprises a display unit 40 such as a CRT or LCD display, a CPU 30, a tuner 36 that receives the radio wave and reproduces the audio and video signal, an IP data transferring unit 33 which sends and receives the data via an IP connection, a temporary storage device 42 such as a small capacity hard disk drive that stores the data from the IP data transferring unit 33, a memory 32 which stores the data to show the program in real-time, an image converter 38 which converts the data from the memory 33 to a format suitable for sending to the display unit, a DMA controller 37 which transfers the data from the memory 32 to the image converter 38, an image selector 39 which selects the data flow between the tuner 36 and the image converter 38, buttons (not drawn), a remote controller (not drawn), etc.

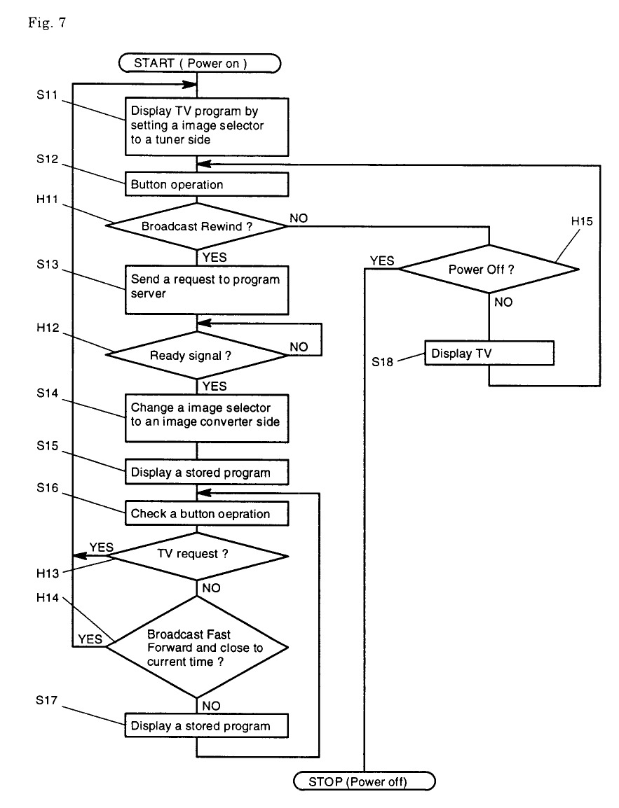

FIG. 7 is a flow chart for controlling the DTV receiver. In this example, the broadcast program is always shown just after the DTV receiver is turned on (S11). When a viewer wants to watch a program that was previously broadcast on the channel that the viewer is currently watching, a rewind operation is input on the receiver itself or on a remote controller. The CPU 30 then sends to the program server (S13) the CPU's own identification code along with a request for sending a stored program backwards starting with the most recently stored information via IP data transferring unit 33.

The program server reads the stored program from a real-time storage means, then sends the ready signal for a transfer to the receiver and starts to send the stored program starting with the most recently stored information. The receiver's CPU 30 subsequently gets the ready signal from the program server and changes the image selector 39 to the image converter input to show the stored program. With this sequence a viewer can watch a stored program in the same manner as replaying the stored program on a local VTR.

When an operation to switch to a current broadcast program is done while a stored program is being shown, CPU 30 changes the image selector 39 back to the image from the tuner 36 to show the current broadcast program (H13 to S11). When a fast forward operation is done at a point close enough to the current time, CPU 30 changes the image selector 39 back to the image from the tuner 36 to automatically show the current broadcast (H14 to S11).

This DTV receiver can be all in one device, but it can also be separated into a monitor part mainly for showing the image and a set top box part mainly for controlling the IP connection.

According to embodiment 3, a viewer can easily watch a previously broadcast program and a current broadcast program with one piece of equipment. In embodiment 3, the broadcast program comes from an antenna, but it can also come from a cable TV line or an IP connection.

### Embodiment 4

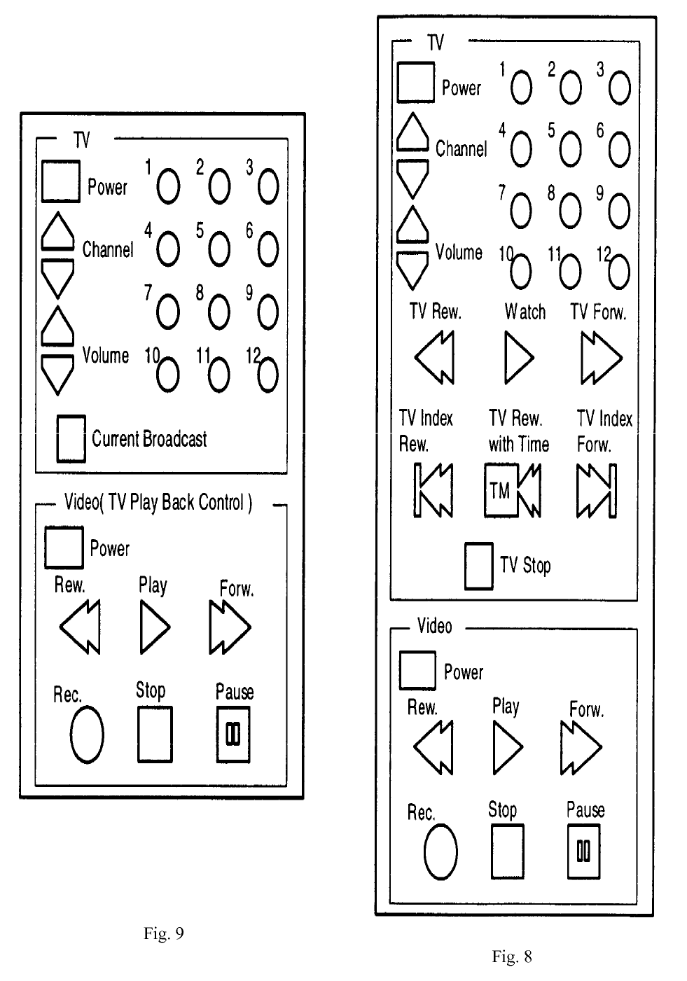

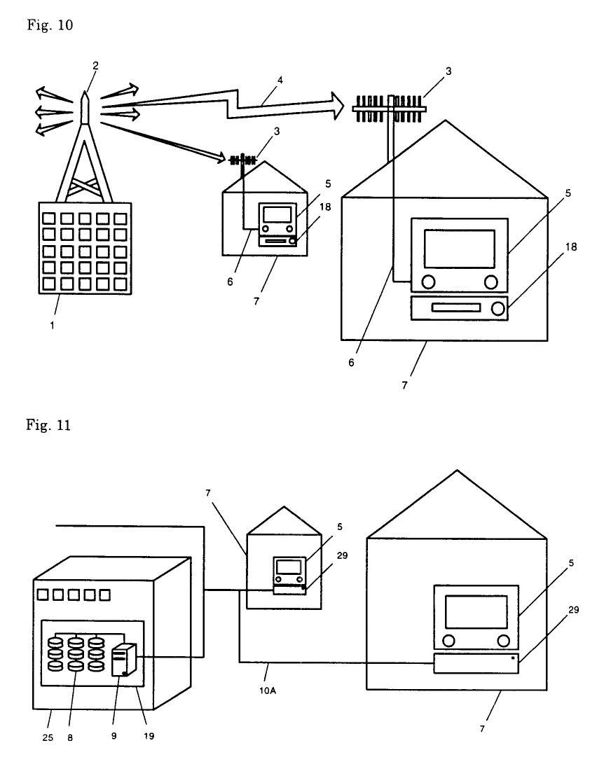

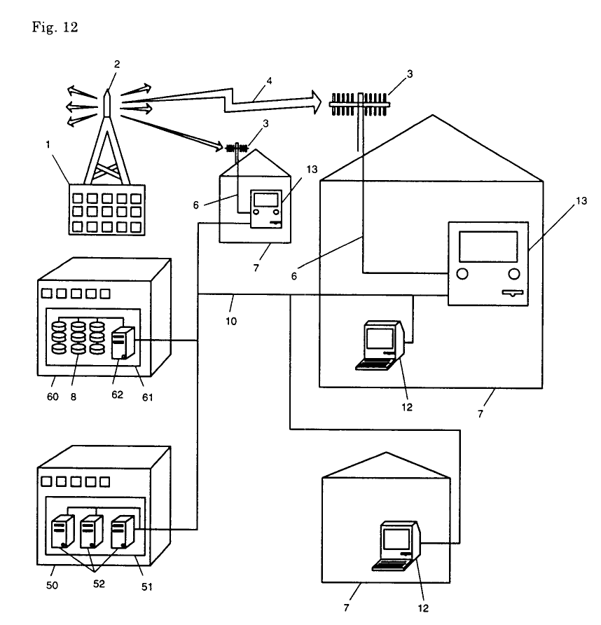

FIG. 8 shows an arrangement of buttons on a remote controller used for the present embodiment. In the TV section are the “Broadcast Rewind” button, the “Broadcast Fast Forward” button, the “Broadcast Index Rewind” button, the “Broadcast Index Fast Forward” button, and the “Broadcast Rewind with Time” button relating to the present embodiment. They are dedicated buttons for easy operation because the effects of the buttons are different from the usual VTR operations. Thus the buttons are explicitly located in the TV section.

When the “Broadcast Rewind” button is pushed, the receiver sends a request for sending a stored program backwards starting with the most recently stored information. When the “Broadcast Fast Forward” button is pushed, the receiver sends a request for sending the newer portions of the stored program. When the “Broadcast Index Rewind” button is pushed, the receiver sends a request for sending a stored program forward starting at a time that is stepped back, at a predetermined period, from the current point in the program. When the “Broadcast Index Fast Forward” button is pushed, the receiver sends a request for sending a stored program forward starting at a time that is stepped forward, at a predetermined period, from the current point in the program. When the “Broadcast Rewind with Time” button is pushed, the receiver sends a request for sending a stored program forward starting at the indicated time.

This is a remote controller for both TV and VTR, but it can also be used only for TV without the VTR section.

According to embodiment 4, a viewer can easily send a request for sending a stored program backward starting with the most recently stored information. A viewer can also easily send a request for sending a stored program forward starting at an indicated time in the past. Furthermore, a viewer can easily send a request for sending a stored program forward from a time stepped back, at a predetermined period, from the current point in the program.

### Embodiment 5

FIG. 9 is an example of a remote controller used for embodiment 5. It has a dedicated “Current Broadcast” button in the TV section for going back to a broadcast program when a stored program is being shown. The other buttons for showing a stored program can be merged with the VTR section by a second function operation to reduce the number of buttons. Because “Broadcast Rewind” is similar to a VTR's “Rewind” operation, “Broadcast Fast Forward” is similar to a VTR's “Fast Forward” operation, “Broadcast Index Rewind” is similar to a VTR's “Index Rewind” operation, “Broadcast Index Fast Forward” is similar to a VTR's “Index Fast Forward” operation, and “Broadcast Rewind with Time” is similar to a VTR's “Rewind with Time” operation, a viewer can easily realize how to use them.

But switching back to a current broadcasting program is quite different from any VTR operation. If the button for this operation is merged with another TV or VTR operation, a viewer may be confused. This operation also happens very often while a stored program is being shown, and therefore should be controlled by a dedicated button for the viewer's convenience.

According to embodiment 5 a viewer can easily switch back from a stored program to a current broadcasting program.

### Embodiment 6

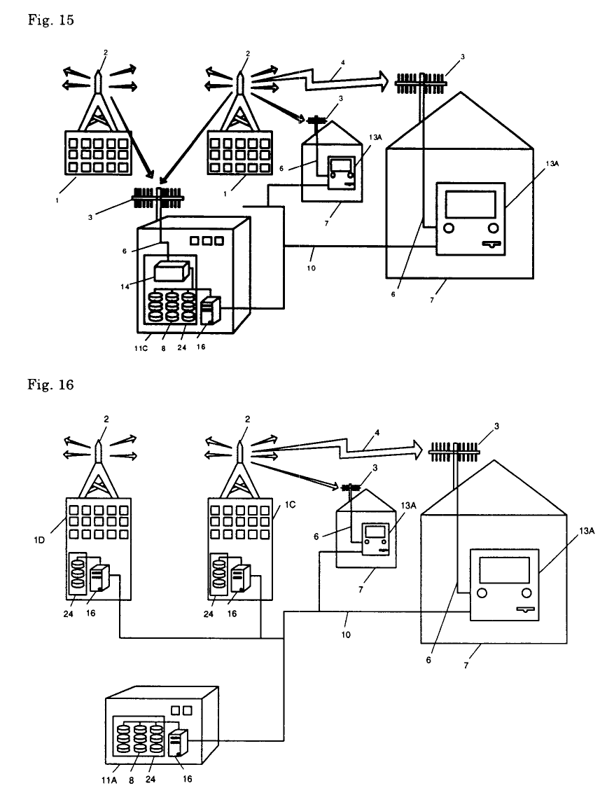

FIG. 15 is a conceptual diagram of embodiment 6. This program server system adopts a method of the present invention.

The broadcast stations 1 transmit programs to a plurality of receivers on a radio wave 4 through transmitting antennas 2. The TV or radio receiver receives the programs by receiving the radio waves through a receiving antenna 3 at each house 7. These broadcast programs are stored in parallel with the broadcast in a real-time storage means 24 at a multi channel program storing center 11C. The huge volume storage device 8 is kept in the real-time storage means 24. The storage device comprises a videotape, digital video disk, or hard disk drive. In this example, the multi channel program storing center 11C is located in a separate building from the broadcast stations, and the receiving antenna 3 is equipped in the same way as the antenna for house 7.

This multi channel program storing center 11C can be located in one of the broadcast stations itself. The broadcast program from that broadcast station would be easily and directly transferred to the real-time storage means 24 without using the radio waves.

When a viewer is watching a broadcast program on a DTV 13A, the program information is broadcast on radio waves to a plurality of receivers. On the other hand, when a viewer wants to watch a previously broadcast program picked from a newspaper's TV column or an electronic TV guide, an operation for a request for sending a program identified by its broadcast station and its original broadcast time is done. For example, the operation comprises selecting a TV channel, pushing the “Broadcast Rewind with Time” button, and inputting a time using the numerical buttons on the remote controller. Then the DTV 13A sends the request to the individual transferring controller 16 of the multi channel program storing center 11C. When the individual transferring controller 16 gets a request, a stored program of the indicated broadcast station and the indicated time is read from the storage device 8 and the stored program is sent to the DTV 13A individually via an IP connection. The DTV 13A changes the selector to select the stored program so that the indicated program is shown to the viewer. To enter information for a previously broadcast program, a conventional program identification code commonly used to program a VTR can be used.

Using embodiment 6, a viewer can easily watch any previously broadcast program without using a huge local VTR and without waiting to register the program onto a VOD server. A VTR requires setting the VTR to record prior to the actual recording, but no prior setting is required in embodiment 6. There is already a TV system to record current programs to a small local storing means to get the play back function for a short period, but there is no limitation on how far back a viewer can go using embodiment 6. Furthermore, the number of broadcast stations a VTR can simultaneously record from is limited by the number of tuners in the VTR, but there is no limitation on the number of broadcast stations that embodiment 6 can play back.

Furthermore, the broadcast can be a streaming video on the IP connection instead of radio waves. But when the broadcasting is done on the radio waves and the multi channel program storing center 11C is receiving the programs with an antenna identical to those used in houses 7, the total data transaction amount can be much smaller than the case where the broadcast is done using full video streaming.

### Embodiment 7

FIG. 16 indicates a conceptual diagram of embodiment 7. This program index server system adopts a method of the present invention.

The broadcast stations IC and ID transmit programs to a plurality of receivers on a radio wave 4 via a transmitting antenna 2 and send an index related to each broadcast program to a multi channel index storing center 11A. The index of the broadcast programs is stored in a real-time storage means 24 at a multi channel index storing center 11A. In contrast to embodiment 6, the index data comprises an identification code for the broadcast station, the broadcast time, the length of the program, the type of the program, an actor's name, etc, so the storage device can be much smaller than that in embodiment 6. The hard disk drive is suitable for this purpose because of its random access availability. The actual program information should be stored at the broadcast station itself or in a corresponding storage device in some other place accessible to the broadcast station.

When a viewer is watching a current broadcasting program, the program is provided via radio wave. On the other hand, when a viewer wants to watch a previously broadcast program picked from a newspaper's TV column or an electronic program guide, an operation for a request for sending a program identified by its broadcast station and its original broadcast time is done in the same manner as in embodiment 6. The DTV 13A then sends the request to the individual transferring controller 16 of the multi channel index storing center 11A. When the individual transferring controller 16 gets the request, the index of the indicated broadcast station and indicated original broadcast time is read from a storage device 8 and sent to the DTV 13A individually via an IP connection. At the same time, the index is also sent to the indicated broadcast station or a corresponding real-time storing means 24 of the broadcast station. The DTV 13A then changes the selector to select the stored program to show the indicated program to the viewer while the broadcast station or the corresponding storage device starts to send the stored program corresponding to the index.

With this sequence, a viewer can easily watch any previously broadcast program without using a huge local VTR and without waiting to register the program onto a VOD server.

Thus, in embodiment 7, only the index information is stored at a multi channel index storing center 11A. Consequently, the storage device can be much smaller and the total data transaction on the IP connection can be much smaller than in embodiment 6.

In the above example, when a request for sending a program identified by its broadcast station and its original broadcast time is sent to an individual transferring controller 16, the individual transferring controller 16 sends a command to connect the broadcast station with the DTV 13A. However, this command can be sent to the DTV 13A first along with identification information for the broadcast station. Or it can be sent to the broadcast station first along with identification information for the individual DTV 13A. Thus the server needs to only handle indexes, resulting in a quick response to a DTV 13A request, and the total transaction can be reduced.

There are also several options to set up a program server and a program index server. When a broadcast station has a storage device for an index and a storing device for actual program information, the broadcast program and the index are both easily stored by the broadcast station.

Embodiment 6 and embodiment 7 can also be merged. If a broadcast station doesn't have a program server for itself, then it can ask a multi channel program storing center 11C to store its programs. But if the broadcast station has a program server, then it can ask the multi channel program storing center 11C to store only the indexes. The multi channel program storing center 11C can have a storage device for the indexes. In this case, all requests from a DTV 13A are collected by an individual transferring controller 16 of this multi channel program storing center 11C. When the required stored program is in the real-time storage means 24, the stored program is read from it and sent to the DTV 13A. But if the indicated stored program is in the real-time storage means for indexes, then the request is sent to the program server of the indicated broadcast station.

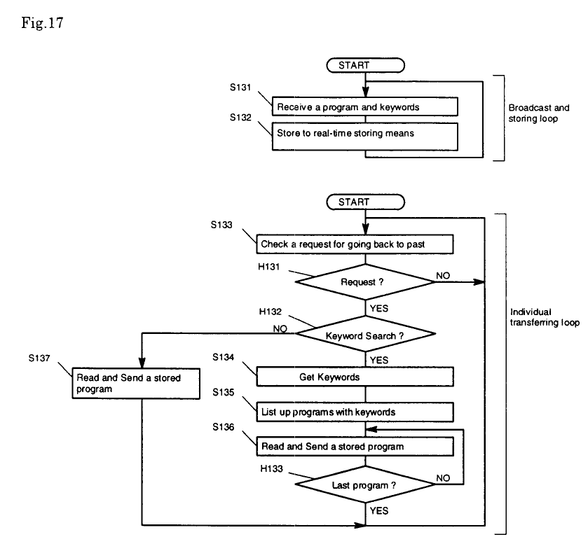

FIG. 17 is a flow chart explaining the eighteenth aspect of the present invention in embodiment 6. In the real-time storage means 24 at a multi channel program storing center 11C, keywords are stored along with program information, which include data such as the title, the region of the program, the actors' names, an advertising client's name, any information in the index, etc. Even when actual program information is stored to VTR, the keywords should be stored to a random access medium such as a hard disk drive because the keywords are randomly accessed later for searching programs.

The individual transferring controller 16 waits for a request for sending a program identified by its broadcast station and its original broadcast time (S133, H131). During a request the controller checks whether keyword searching is requested or not (H132). If keyword searching is requested, the controller searches the storage device that stores the keywords (S135). If the request is an old order, then the controller sends the oldest program first in a matched list to the DTV 13A. After sending the oldest program the controller sends the second oldest program. All listed programs are sent in series. The programs of multiple broadcast stations can be listed, so a viewer can watch, in series, programs that are related to one or more keywords and from multiple broadcast stations. For example, if a viewer indicates “sports news” as a keyword with an old order, all programs relating to “sports news” from all broadcast stations can be watched in series. The order can be a new order, a correlation order to a keyword, etc. When keyword searching is not requested, a stored program identified by its broadcast station and its original broadcast time is merely sent to the DTV 13A (S137). With this operation, one can easily watch a series of programs, from multiple broadcast stations, that are related to one or more keywords.

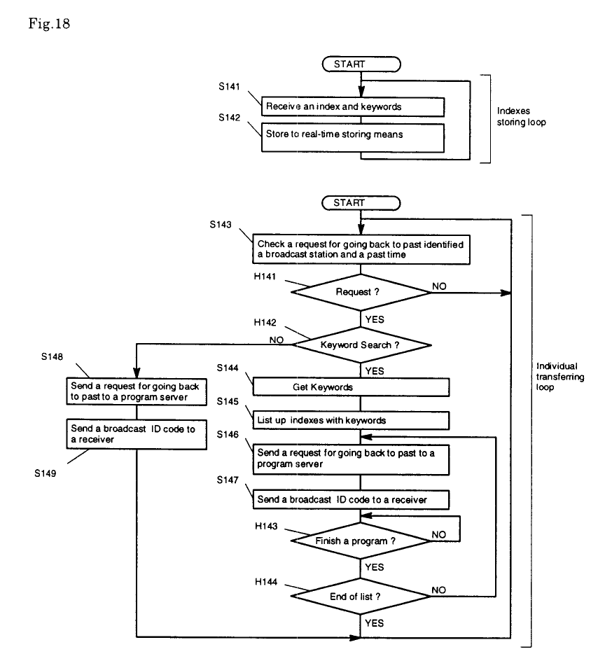

Similar operation is available in embodiment 7. In FIG. 18 a multi channel index storing center 11A stores keywords along with indexes for broadcast stations (S141, S142). When an individual transferring controller 16 receives a request from a DTV 13A for sending a program identified by its broadcast station and its original broadcast time (S143, H141), the controller checks whether keyword searching is requested or not (H142). If keyword searching is requested, the controller searches the storage device for multiple broadcast stations and lists all matched indexes (S144, S145). The controller 16 sends a command to a broadcast station or a program server corresponding to the broadcast station identified by a first index of the list (S146). The command includes the identification code of the DTV 13A and a request for sending a program identified by its broadcast station and its original broadcast time. In parallel, the controller 16 sends another command to the DTV 13A. That command includes an identification code for the broadcast station or an identification code for the program server corresponding to the broadcast station (S147). The DTV 13A then receives the stored program from the broadcast station or the program server. During the transfer of the stored program from the broadcast station or the program server to the DTV 13A, the controller 16 is waiting until the DTV 13A receives all information of the stored program (H143). After that, if there are more indexes in the list, the controller 16 sends a new command to a new broadcast station or a new program server for the next program while sending a new command to the DTV 13A.

To achieve the twentieth aspect of the present invention, at S136 of FIG. 17 when the individual transferring controller 16 receives a command from the DTV 13A to switch to a new channel, the controller 16 stops providing the current stored program to the DTV 13A and sends another stored program of a new broadcast station indicated by the DTV 13A. The new stored program was originally broadcast at approximately the same time as the currently shown program. In this case, the new stored program can be shown starting at exactly the point in time that the currently shown program was stopped, but it may be better to start from the beginning of the new stored program. It's easier for the viewer to watch. With this operation the transition to a new channel is easily done by a server operation among past broadcast programs.

This can also be easily achieved on embodiment 7 and corresponds to the twenty-first aspect of the present invention.

To achieve the twenty-second aspect of the present invention, at S136 of FIG. 17 when the individual transferring controller 16 receives a request from the DTV 13A to send a program table, the controller 16 collects information for programs from multiple broadcast stations for a predetermined period that includes the original broadcast time of the currently shown stored program. Then the controller creates a program table and sends it to the DTV 13A. The data size of the program table is very small compared with the actual program data, so this operation can be easily done in parallel with the transfer of the stored program.

The DTV 13A shows the program table to a viewer. The viewer then chooses one program from the table, and a new request for sending a program identified by its broadcast station and its original broadcast time is issued again. With this operation the program table for multiple broadcast stations is easily available anytime.

### Embodiment 8

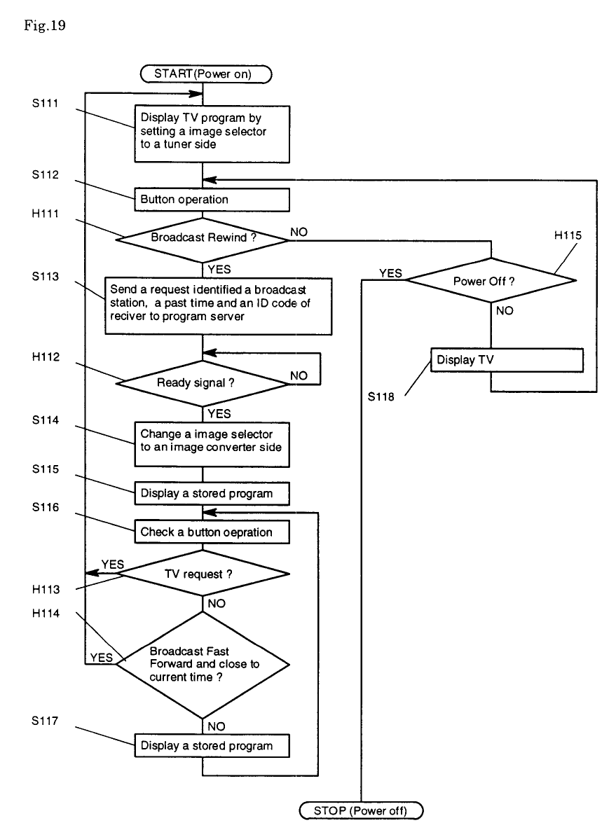

FIG. 19 indicates a flow chart for controlling the receiver explained by FIG. 6 for embodiment 8. The operation for a multi channel program storing center 11C is assumed in this flow chart. In this example, the broadcasting program is always shown just after the receiver is turned on (S111). When a viewer wants to watch a previously broadcast program, an operation for selecting a channel and indicating a time is done on the DTV 13A itself or on a remote controller. The CPU 30 then sends the receiver's identification code with a request for sending a program identified by its broadcast station and its original broadcast time via the IP data transferring unit 33 to the individual transferring controller 16 of the program server (S113).

The individual transferring controller 16 reads the stored program from storage device 8, sends the ready signal for transfer to the DTV 13A, and starts to send the stored program backwards starting from the most recently stored information. The CPU 30 of DTV 13A gets the ready signal from the individual transferring controller 16 and changes the image selector 39 to select the image converter 38 input to show the stored program. With this sequence a viewer can watch the stored program in the same manner as replaying a program on the VTR.

When an operation for watching a current broadcast program is done while watching a stored program, CPU 30 changes the image selector 39 back to the image from the tuner 36 to show the current broadcasting program (H113 to S111). When the fast forward operation is done at a point in time close enough to the current time, CPU 30 automatically changes the image selector 39 back to the image from the tuner 36 to show the current broadcast (H114 to S111).

### Embodiment 9

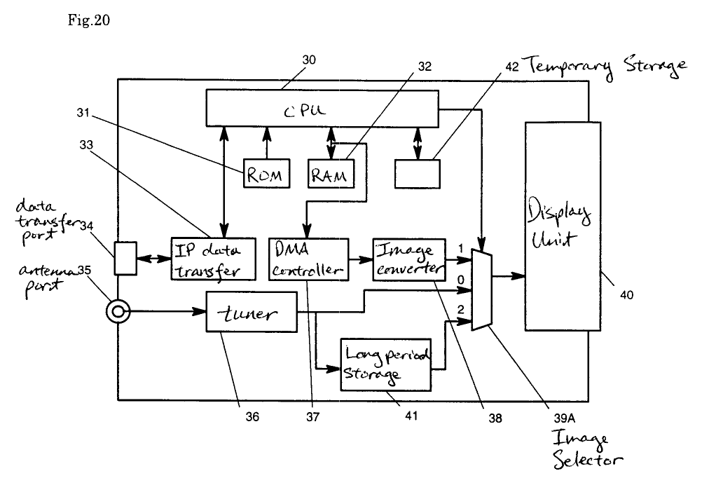

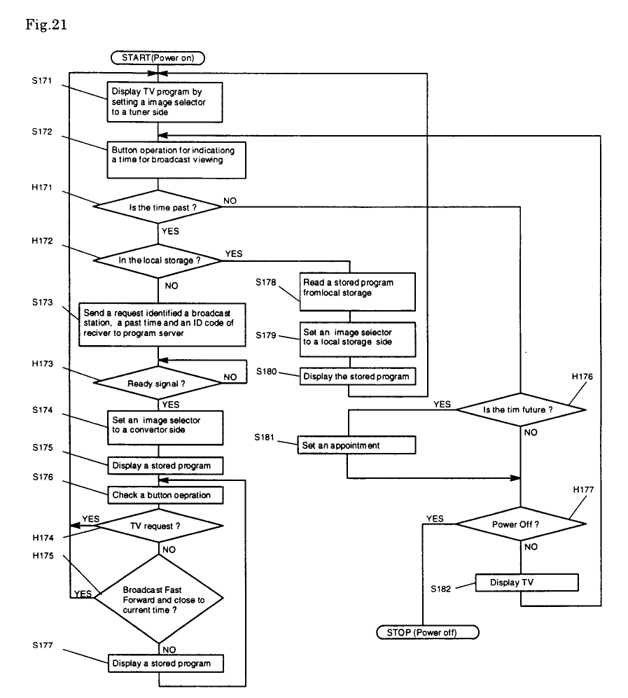

FIG. 20 is a block diagram of another example of a DTV receiver. This receiver has an additional long period storage device 41. A random access media like a hard disk drive or a digital video disk is better than a VTR for the long period storage device.

FIG. 21 is a flow chart for controlling this receiver. The operation for a multi channel program storing center 11C is assumed in this flow chart. When a viewer wants to watch a broadcast program for an indicated time, an operation for selecting a channel and indicating that time is done on the receiver itself or on a remote controller. The CPU 30 then checks whether the indicated time is in the past or whether the indicated time is in the future (H171, H176). If the indicated time is the current time, then CPU 30 just shows a broadcasting program (S182). If the indicated time is in the future, the CPU 30 records the channel and the indicated time to a list of recording appointments (S181). At the indicated time, the receiver stores the program to the long period storage device 41. If there is only one tuner and a viewer is watching another channel at the indicated appointment time, it's difficult to store the indicated program on the indicated channel. So two or more tuners are better for this operation.

When the indicated time is in the past, CPU 30 checks the long period storage device 41 first (H172). If the indicated program is stored in the long period storage device 41, CPU 30 reads the stored program and shows it to the viewer (S178, S179, S180). If the indicated program is not stored in the long period storage device 41, the receiver sends a request for sending a program identified by its broadcast station and its original broadcast time to the individual transferring controller 16 (S173). Subsequent operation is the same as in embodiment 8.

In embodiment 9, the IP connection is sometimes in a bad condition. In this case, transmission of the stored program may be stopped randomly. For IP connection problems that occur over a short period of time, a stable showing is available with a temporary storage device 42. But IP connection problems that last for longer periods of time may cause stoppage during the showing of the stored program. In this case, the full downloading method—Batch Mode—is effective. In the Batch Mode, the indicated stored program is transferred to the DTV 13A and the DTV 13A stores all of the program information to the long period storage device 41 before showing the stored program to a viewer. After finishing the transfer, the DTV 13A shows “Ready” to the viewer. Then the viewer can watch the stored program without transfer problems related to the quality of the IP connection.

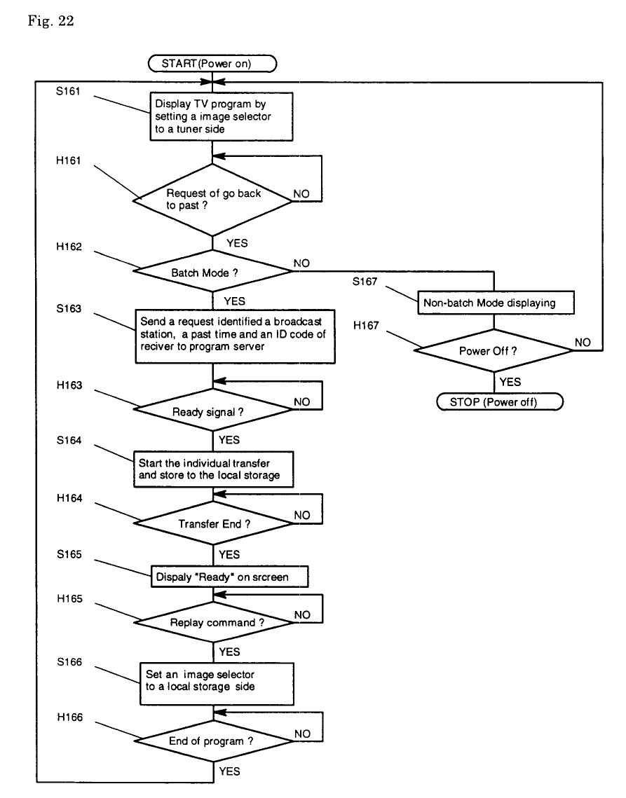

FIG. 22 is a flow chart for controlling the Batch Mode. The operation for a multi channel program storing center 11C is assumed in this flow chart. In this example, the broadcast program is shown just after the DTV 13A is turned on (S161). When a viewer makes an operation for a request for sending a program identified by its broadcast station and its original broadcast time, the CPU 30 checks whether Batch Mode is indicated or not (H162). If Batch Mode is not indicated, the normal operation is done as shown in FIG. 21 (S167). If Batch Mode is indicated, the CPU 30 sends a request for sending a program identified by its broadcast station and its original broadcast time to the individual transferring controller 16 (S163). The CPU 30 waits for a ready signal (H163), then stores all of the program information to long period storage device 41 (S164). In contrast to FIG. 21, the CPU 30 never shows the program to a viewer during the transfer. After finishing the transfer, the CPU 30 shows the “Ready” sign to the viewer (S165) and waits for a command from the viewer to start a showing (H165). After confirmation by the viewer, the CPU 30 switches the image selector 39A to select the long period storage device 41 side (S166) and starts to show the stored program.

When a viewer indicates multiple previously broadcast programs at one time, it takes a long time to download and store all the programs to long period storage device 41. So CPU 30 should start showing the first program after it has been downloaded. Furthermore, the downloading and storing can be done automatically when a viewer is not watching the TV (for example, at midnight or in the absence of the viewer). In this case, the viewer can watch the stored programs later without waiting.

For this DTV receiver, when a viewer makes an operation to change the channel while watching a stored program, the receiver can send new requests for sending a program identified by its broadcast station and its original broadcast time. This transition can be achieved by a program server by sending a new broadcast station's information as described in the twentieth aspect of the present invention, but the receiver can do an equivalent operation for a viewer by indicating a new broadcast station and a time. When the transition to a new channel can be controlled by the receiver, the number of requests to a server is reduced, thus allowing for stable system operation. If the receiver is equipped with a long period storage device, the storage device should be checked first when the channel is changed.

What is claimed is:

1. An apparatus, comprising:
a remote controller including a first dedicated button for requesting a program server to send a stored program stepped backward a period of time starting from the most recently stored information, a module to establish communications between a receiver that calls the program server and the remote controller, logic configured to initiate a request to the program server to send the stored program backward starting from the most recently stored information to when the first dedicated button is activated.

2. The apparatus of claim 1, wherein the remote includes at least four or more dedicated buttons including the first dedicated button, as well as a second dedicated button configured to request the program server to send the stored program stepped forward a period of time starting from the past indicated time, a third dedicated button configured to request the program server to send the stored program stepped forward a period of time starting from a time stepped back at a predetermined period from the current point in the program, a fourth dedicated button configured to switch to a live broadcast program while the stored program from the program server is being shown; and a set of alpha numeric keys to allow a user to enter alpha numeric values into a user interface presented by either a receiver or the program server.

3. An apparatus, comprising:
a remote controller including a first dedicated button for requesting a program server to send a stored program stepped forward a period of time starting from a past indicated time, a module to establish communications between a receiver that calls the program server and the remote controller, logic configured to initiate a request to the program server to send the stored program the stored program forward starting from a past indicated time to when the dedicated button is activated.

4. The apparatus of claim 3, wherein the remote includes at least four or more dedicated buttons including the first dedicated button, as well as a second dedicated button configured to request the program server to send a stored program stepped backward a period of time starting from the most recently stored information e, a third dedicated button configured to request the program server to send the stored program stepped forward a period of time starting from a time stepped back at a predetermined period from the current point in the program, a fourth dedicated button configured to switch to a live broadcast program while the stored program from the program server is being shown; a set of alpha numeric keys to allow a user to enter alpha numeric values into a user interface presented by either a receiver or the program server, a power button to turn the receiver on and off, a channel up button and a channel down button.

5. An apparatus, comprising:
a remote controller including a first dedicated button for requesting a program server to send a stored program stepped forward a period of time starting from a time stepped back at a predetermined period from the current point in the program, a module to establish communications between the program server and the remote controller, logic configured to request the program server to send the stored program forward starting from a time stepped back at a predetermined period from the current point in the program when the dedicated button is activated.

6. The apparatus of claim 5, wherein the remote includes at least four or more dedicated buttons including the first dedicated button, as well as a second dedicated button configured to request the program server to send a stored program stepped backward a period of time starting from the most recently stored information e, a third dedicated button configured to request the program server to send the stored program stepped forward a period of time starting from the past indicated time, a fourth dedicated button configured to switch to a live broadcast program while the stored program from the program server is being shown; a set of alpha numeric keys to allow a user to enter alpha numeric values into a user interface presented by either a receiver or the program server, a power button to turn the receiver on and off, a channel up button, and a channel down button.

7. An apparatus, comprising:
a remote controller including a dedicated button for switching to a broadcast program while a stored program from a program server is being shown, a module to establish communications between the program server and the remote controller, logic configured to switching to the broadcast program while the stored program from a program server is being shown when the dedicated button is activated.

8. The apparatus of claim 7, wherein the remote includes at least four or more dedicated buttons including the first dedicated button, as well as a rewind button when pushed to trigger a receiver to send a request to the program server for sending a stored program backwards starting with the most recently stored information, a fast forward button when pushed to trigger the receiver to send a request to the program server for sending newer portions of the stored program, an index rewind button when pushed to trigger the receiver to send a request to the program server for sending a stored program forward starting at a time that is stepped back, at a predetermined period, from a current point in the stored program, an index fast forward button when pushed to trigger the receiver to send a request to the program server for sending a stored program forward starting at a time that is stepped forward, at a predetermined period, from the current point in the stored program, a rewind with time button when pushed to trigger the receiver to send a request to the program server for sending the stored program forward starting at an indicated time.

9. The apparatus of claim 8, wherein the remote includes a time indicator configured to display a time value entered by a user of an amount of time the user of the remote wants to watch a program starting from an indicated past point in time during a live broadcast program that is being shown.

10. The apparatus of claim 8, wherein the remote includes a separate set of button for operation of a video playing device external to the receiver.

11. The apparatus of claim 9, wherein the remote includes a mode switch and the four or more dedicated buttons are always dedicated to operations involving the program server and the receiver.

12. The apparatus of claim 9, wherein the four or more dedicated buttons may have merged functionality to operations involving the program server and the receiver as well as to operations of a video playing device external to the receiver depending upon a mode of operation the remote is currently in.
